(19) United States
(12) Patent Application Publication
(10) Pub. No.: US 2023/0221626 A1
(43) Pub. Date: Jul. 13, 2023

(54) SURROUND SHOOTING DEVICE

(71) Applicant: Dongguan City GeShengMei Industrial Co., Ltd, Dongguan City (CN)

(72) Inventor: Taotao Lei, Dongguan City (CN)

(21) Appl. No.: 18/185,323

(22) Filed: Mar. 16, 2023

(30) Foreign Application Priority Data
Nov. 11, 2022 (CN) 202223015070.3

(51) Int. Cl. G03B 17/56; F16M 11/08; F16M 11/18

(52) U.S. Cl. CPC G03B 17/561; F16M 11/08; F16M 11/18

(57) ABSTRACT

A surround shooting device includes a platform, a shooting stand, a rotating motor, an annular spinner and a gear. The annular spinner is rotatable and arranged around the platform, the annular spinner is provided with a gear ring structure extended along a rotation direction of the annular spinner, the platform has a top that is protuberant over the annular spinner and a bottom extended from the annular spinner, a lower end of the shooting stand is connected with the annular spinner, the gear is located in and meshes with the gear ring structure, the rotating motor is installed in the platform and drives the gear to rotate, accordingly, the annular spinner together with the shooting stand is actuated to rotate around the platform. The structure of the device is stable and simple.

### FIELD OF THE INVENTION

The application relates to the technical field of camera shooting equipment, in particular to a surround shooting device which is used in occasions such as outdoor activities, parties, gathering etc. to shoot a selfies photo or video.

### BACKGROUND OF THE INVENTION

As known, a 360 Photo Booth is a rotation shooting platform for camera shooting at 360 degrees, which is popular in social platforms.

Chinese patent Application No. 202122947239.8 discloses an anti-shaking rotation shooting platform including a support platform, a support base, a spindle, a rotatable shooting stand, a support stand, and a driving assembly. The support platform and support base are connected through the spindle. The shooting stand includes a first connecting end for installing a shooting apparatus and a second connecting end for connecting with the support stand, the support stand is connected with the support base, and the driving assembly is for driving the shooting stand to rotate around the support platform. Because the support platform is connected with the support base through the spindle, the shooting stand is connected with the support stand which is connected with the support base, so that the support stand and the spindle are separated, therefore, the force generated by the user thereon is first transmitted to the support base through the support platform and the spindle, while the support base is standing on the ground to absorb the shock. The support stand is not directly connected with the spindle, thus the shooting stand connected with the support part is almost not affected by the force transmission of user. Therefore, the shooting apparatus connected thereon is stable, and shock and shake is prevented, thereby improving the shooting quality.

However, a horizontal segment of the shooting stand is located in the space between the support base and the support platform, and a vertical segment (namely the cantilever) of the shooting stand is placed at the side of the support platform, therefore, on one hand, the suspension length of the shooting stand relative to the support stand is increased to increase the bearing load of the support stand; on the other hand, the cooperation of the shooting stand, the support platform and the support base is more complicated, as it's necessary to reserve space between the support platform and support base for the arrangement and rotation of the horizontal segment.

Therefore, there is an urgent need for an improved surround shooting device to overcome the above defects.

### SUMMARY OF THE INVENTION

An objective of the present application is to provide a surround shooting device which stabilizes a shooting stand and a shooting apparatus fixed thereon, and simplifies the rotation structure of the shooting stand.

To achieve the above objective, the present application provides a surround shooting device including a platform for standing, a shooting stand for fixing a shooting apparatus, a rotating motor, an annular spinner and a gear, wherein the annular spinner is rotatable and arranged around the platform, the annular spinner is provided with a gear ring structure extended along a rotation direction of the annular spinner, the platform has a top that is protuberant over the annular spinner and a bottom extended from the annular spinner, a lower end of the shooting stand is connected with the annular spinner, the gear is located in and meshes with the gear ring structure, the rotating motor is installed in the platform and drives the gear to rotate, accordingly, the annular spinner together with the shooting stand is actuated to rotate around the platform.

In one embodiment, the platform is provided with a receiving chamber running through the bottom of the platform, and a notch formed at a side of the platform and communicated with the receiving chamber; the rotating motor and the gear are received in the receiving chamber, and the gear is further extended out of the notch.

In one embodiment, the rotating motor and the gear are arranged flat respectively.

In one embodiment, the device further includes a worm gear mechanism, a ring clamp, and a battery box, which are received in the receiving chamber, wherein the worm gear mechanism is mounted between the rotating motor and the gear, the ring clamp encircles the rotating motor and is fixedly connected with the platform, and the battery box is electrically connected with the rotating motor.

In one embodiment, a pivoting frame is included, a hinge structure is received in the receiving chamber of the platform, the pivoting frame has a first end hinged with the hinge structure and a second end provided with a wheel, and the pivoting frame is pivoted relative to the platform to provide a folding position and an unfolding position, in the unfolding position, the pivoting frame together with the wheel is unfolded out of the receiving chamber, the surround shooting device is capable of rolling or sliding; while in the folding position, the pivoting frame is completely received in the receiving chamber.

In one embodiment, a pivoting bracket is located at a side wall of the annular spinner, a hinge element is horizontally arranged at a top of the annular spinner, the pivoting bracket is provided with a lug hinged with the hinge element, the lower end of the shooting stand is connected with the pivoting bracket, the shooting stand together with the pivoting bracket is pivoted or swings to fold or unfold relative to the platform, and the pivoting bracket is pressed against a sidewall of the annular spinner when the pivoting bracket is unfolded in place.

In one embodiment, the shooting stand is provided with a fixed buckle and a handle located above the fixed buckle, the fixed buckle is configured to buckle with a bottom of the annular spinner or the platform when the shooting stand is folded in place.

In one embodiment, the shooting stand comprises a first electric push rod, an angle adjusting motor and an installing support connected with the shooting apparatus, the angle adjusting motor is connected between a lower end of the installing support and a push part of the first electric push rod, a fixed part of the first electric push rod is hinged with the pivoting bracket to form a hinged center line, and the angle adjusting motor is configured to drive the installing support to pivot relative to the first electric push rod to fold or unfold.

In one embodiment, a plurality of adjusting holes are formed on the pivoting bracket along a pivoting direction thereof, a matching hole is provided on the fixed part of the first electric push rod to match with the adjusting holes, and a pin is inserted into and matching hole and one of the adjusting holes.

In comparison with the prior arts, the annular spinner is rotatable and arranged around, the top of the platform is protuberant over the annular spinner, and the bottom of platform is extended out of the annular spinner, thus the force suffered by the platform may be directly transmitted to the ground, etc., which will not directly affect the stability of the whole structure of the device. At the same time, the annular spinner is provided with a gear ring structure facing the shooting station and extending along the rotation direction of the annular spinner, the gear is located in the gear ring structure and meshes with the gear ring structure, the rotating motor is installed on the shooting station and drives the gear to rotate, and the rotating gear drives the annular spinner and the shooting stand to rotate around the shooting stand through the gear ring structure. In this way, the rotation structures among the rotating motor, the annular spinner and the shooting stand are simplified. Moreover, the lower end of the shooting stand is connected at the annular spinner which is connected around the platform, thus the suspension length of shooting stand relative to the annular spinner may be reduced, thereby improving the stability and the reliability of the rotation.

### BRIEF DESCRIPTION OF THE DRAWINGS

The accompanying drawings facilitate an understanding of the various embodiments of this invention. In such drawings:

FIG. 1 is perspective view of a surround shooting device according to a first embodiment of the invention;

FIG. 2 is an exploded perspective view of the surround shooting device as shown in FIG. 1;

FIG. 3 is another perspective view of the surround shooting device as shown in FIG. 1;

FIG. 4 is an exploded perspective view of the surround shooting device as shown in FIG. 3;

FIG. 5 is a perspective view of the surround shooting device of FIG. 1, after the device is folded and the pivoting frame is unfolded;

FIG. 6 is another perspective view of FIG. 5;

FIG. 7 is perspective view of a surround shooting device according to a second embodiment of the invention;

FIG. 8 is another perspective view of the surround shooting device as shown in FIG. 7;

FIG. 9 is a perspective view of the surround shooting device of FIG. 7, after the device is folded and the pivoting frame is unfolded; and

FIG. 10 is another perspective view of FIG. 9.

### DETAILED DESCRIPTION OF ILLUSTRATED EMBODIMENTS

In order to make the purpose, technical solutions and advantages of the present application more clearly understood, the present application will be described in further detail below with reference to the accompanying drawings and embodiments.

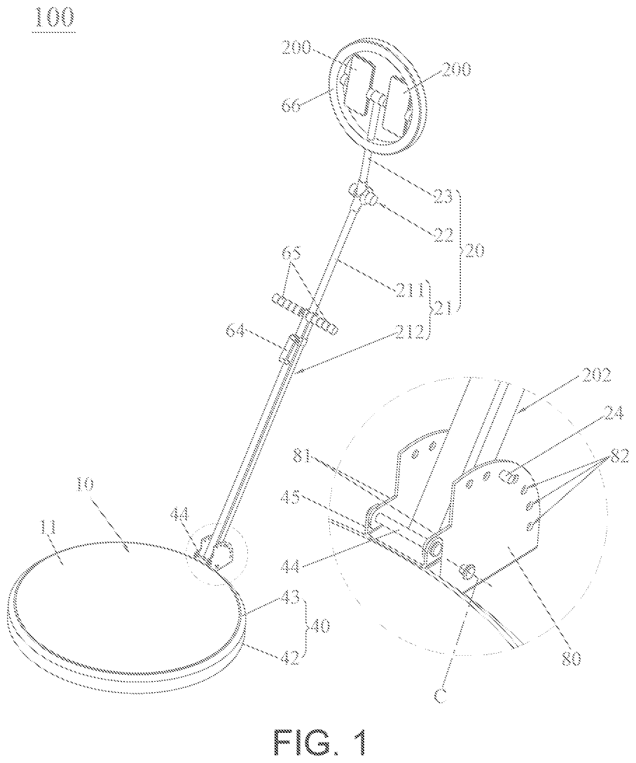

Referring to FIGS. 1-4, the surround shooting device 100 according to a first embodiment of the invention includes a platform 10 for standing, a shooting stand 20, a rotating motor 30, an annular spinner 40 and a gear 50. The upper end of the shooting stand 20 is for connecting with a shooting apparatus 200. As an example shown in FIGS. 1, 4 and 6, the shooting apparatus 200 may be a smart phone with a camera, optionally, it may be a tablet computer with a camera or a digital camera, which is not limited here.

Specifically, the lower end of the shooting stand 20 is connected to the annular spinner 40, so as to drive the shooting stand 20 to rotate. The annular spinner 40 is rotatable and arranged around the platform 10. That is, the platform 10 provides support for the rotation of the annular spinner 40. Optionally, as an example, a plurality of ball bearings arranged in a ring around the platform 10 are provided between the annular spinner 40 and the platform 10, by which a rolling friction is generated between the annular spinner 40 and the platform, thereby improving the smoothness and stability of rotation between the annular spinner 40 and the platform 10. Optionally, a sliding friction may be set between the annular spinner 40 and the platform, according to the actual demands.

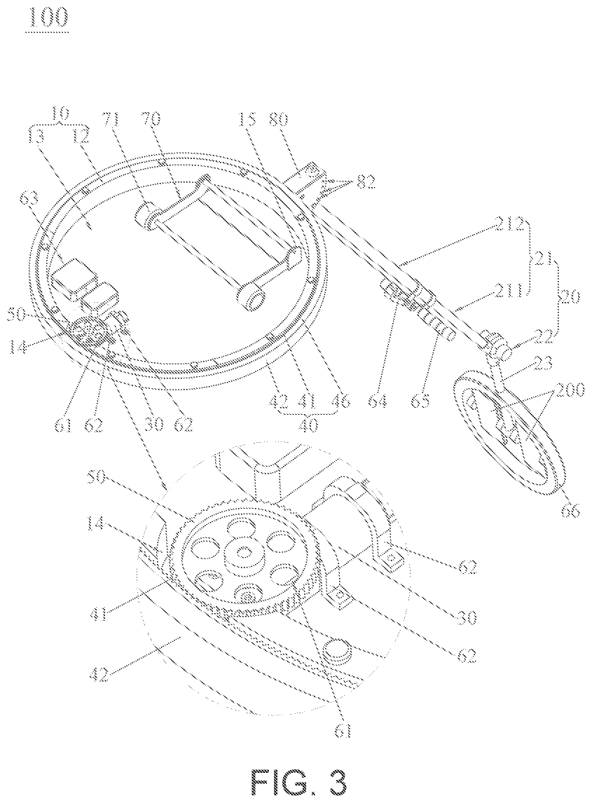

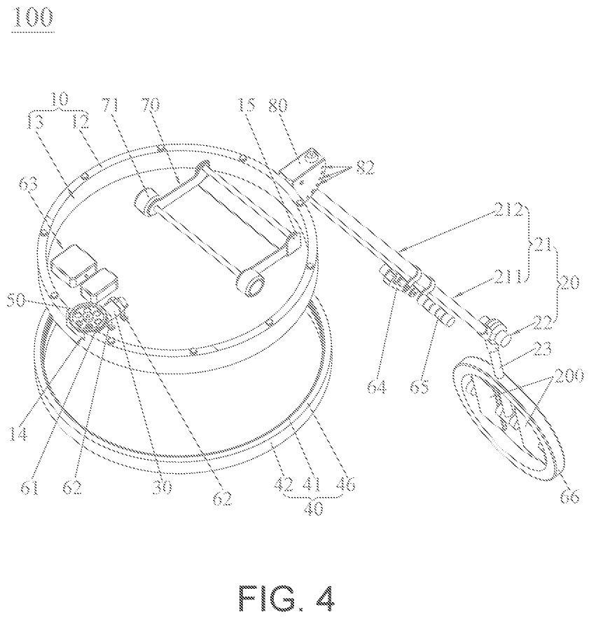

The annular spinner 40 is provided with a gear ring structure 41 that is extended along a rotation direction of the annular spinner 40 (referring to the clockwise or counterclockwise direction in FIG. 3). Optionally, as an example in FIG. 4, the gear ring structure 41 is extended as a full circle so that the annular spinner 40 can rotate in a range of 360 degrees. Understandably, the rotating angle of the body 40 is dependent on the extension direction and length of the gear ring structure 41. A top 11 of the platform 10 is protuberant over the annular spinner 40 to facilitate the support of the user to stand or sit thereon. A bottom 12 of the platform 10 is extended from the annular spinner 40. The gear 50 is located in and meshes with the gear ring structure 41, so as to rotate the annular spinner 4. The rotating motor 30 is installed in the platform 10 and drives the gear 50 to rotate, accordingly, the annular spinner 4 together with the shooting stand 20 is actuated to rotate around the platform 10. In such a way, a surround shooting for different shooting angle and motion effects is achieved.

Specifically, as shown in FIGS. 3 to 5, the platform 10 is provided with a receiving chamber 13 that runs through the bottom 12 of the platform 10, and a notch 14 that is formed at a side of the platform 10 and communicated with the receiving chamber 13. The rotating motor 30 and the gear 50 are built into the receiving chamber 13, and the gear 50 is further extended out of the notch 14 to reasonably utilize the internal space of the platform 10 and make the arrangement more compact.

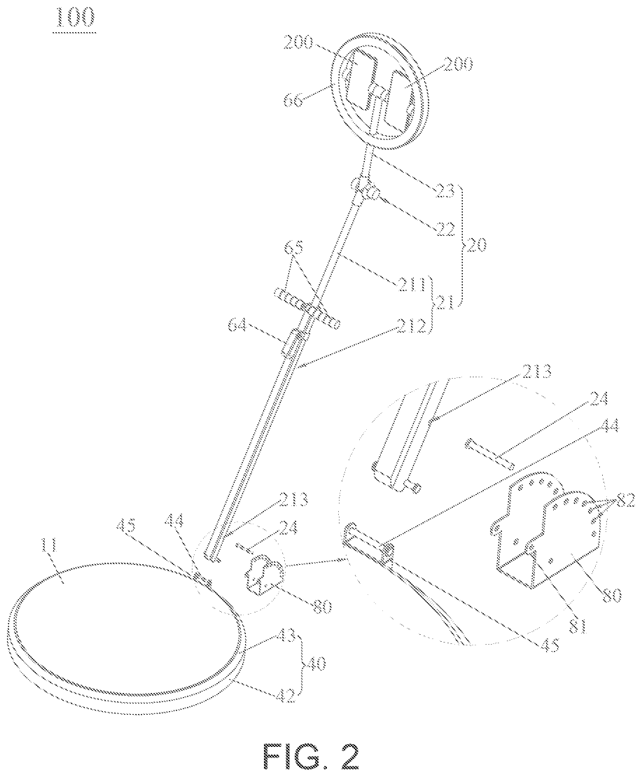

As an embodiment shown in FIG. 2 and FIG. 3, the rotating motor 30 and the gear 50 are arranged flat respectively and received in the receiving chamber 13, to maintain a compact size. Specifically, the surround shooting device 100 of the first embodiment further includes a worm gear mechanism 61, a ring clamp 62, and a battery box 63, which are built into the receiving chamber 13. The worm gear mechanism 61 is mounted between the rotating motor 30 and the gear 50 so that the rotating motor 30 drives the gear 50 to rotate through the worm gear mechanism 61. The ring clamp 62 encircles the rotating motor 30 and is fixedly connected with the platform 10, in such a way, the rotating motor is fixed reliably. The battery box 63 is electrically connected with the rotating motor 60, in which a battery of large capacity may be installed to meet the outdoor use. Optionally, the surround shooting device 100 may use external power by equipping with an external power adapter.

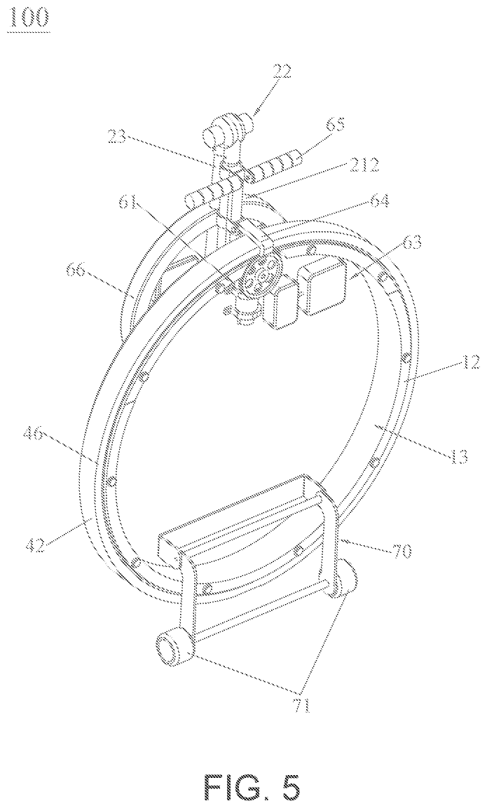

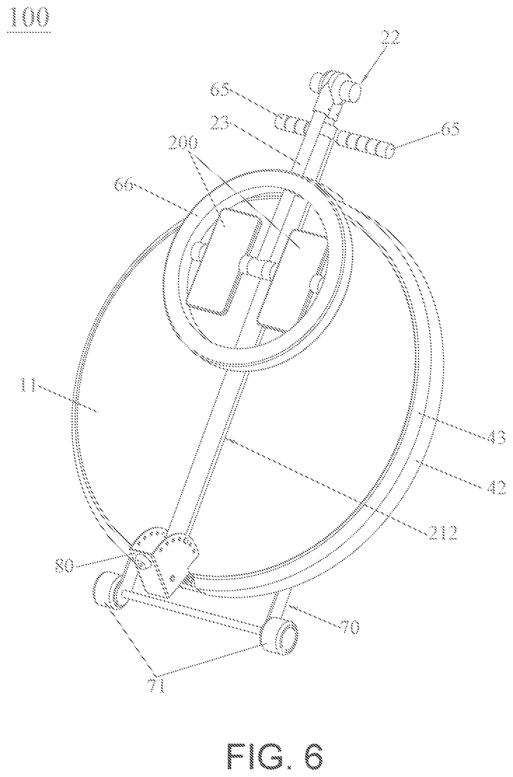

As shown in FIG. 3 to FIG. 6, as an embodiment, the surround shooting device 100 further includes a pivoting frame 70. A hinge structure 15 is built into the receiving chamber 13 of the platform 10. As an example, the hinge structure 15 has a shape of “Li”. A first end of the pivoting frame 70 is hinged with the hinge structure 15, and a second end of the pivoting frame 70 is provided with a wheel 70. In such a configuration, the pivoting frame 70 may be pivoted relative to the platform 10 and has a folding position as shown in FIGS. 3 and 4 and an unfolding position as shown in FIGS. 5 and 6. As shown, when the pivoting frame 70 together with the wheels 71 is unfolded out of the receiving chamber 13, the surround shooting device 100 may roll or slide due to the presence of the wheels 71, to facilitate the carrying. When the pivoting frame 70 is in the folding position, the whole frame 70 is completely received in the receiving chamber 13.

As shown in FIGS. 1 and 2, the surround shooting device 100 of the first embodiment further includes a pivoting bracket 80 located at a side wall of the annular spinner 40. A hinge element 44 is horizontally arranged at the top 43 of the annular spinner 40, preferably, fixed on the top 43 through a hinge base 45 that is in a shape of “␣”, to ensure the reliability between the hinge element 44 and the pivoting bracket 80. The pivoting bracket 80 is provided with a lug hinged with the hinge element 40. The lower end of the shooting stand 20 is connected with the pivoting bracket 80, thus the shooting stand 20 together with the pivoting bracket 80 is pivoted or swings to fold or unfold relative to the platform 10, and the pivoting bracket 80 is pressed against a sidewall 42 of the annular spinner 40 when the pivoting bracket 80 is unfolded in place, as shown in FIG. 2. In such a way, the stability between the shooting stand 20 and the annular spinner 40 may be increased. Furthermore, the pivoting bracket 80 is pressed against the sidewall 42 of the annular spinner 40 by means of a lug 81.

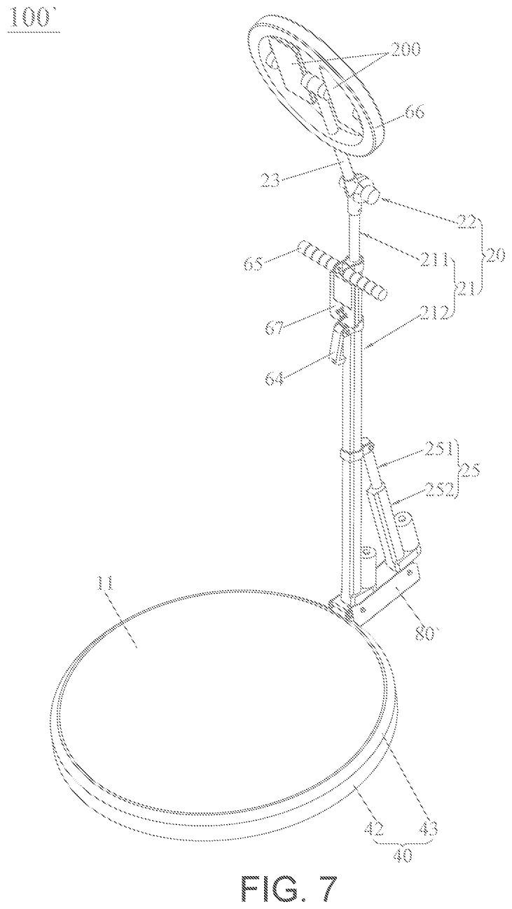

Specifically, in FIG. 1 to FIG. 6, the shooting stand 20 is provided with a fixed buckle 64 and a handle 65 located above the fixed buckle 64. The fixed buckle 64 is configured to buckle with the bottom 46 of the annular spinner 41 when the shooting stand 20 is folded in place, to prevent accidental looseness. Further, the surround shooting device 100 may be dragged by using the handle 65. Specifically, a controller 67 is provided on the shooting stand 20 (see FIG. 7). As an example, the controller 67 is located between the fixed buckle 64 and the handle 65 to control the operation of the rotating motor 30 and the shooting operation of the shooting apparatus 200. The structure and control principle of the controller 67 are already well known in the art, which is not repeated here.

As shown in FIG. 1 and FIG. 2, the shooting stand 20 includes a first electric push rod 21, an angle adjusting motor 22 and an installing support 23 connected with the shooting apparatus 200. The angle adjusting motor 22 is connected between the lower end of the installing support 23 and the push part 211 of the first electric push rod 21, so that the angle adjusting motor 22 may drive the installing support 23 to pivot relative to the first electric push rod 21 to fold or unfold. The folded state is shown in FIG. 6, and the unfolded state is shown in FIG. 4. The fixed part 212 of the first electric push rod 21 is hinged with the pivoting bracket 80 to form a hinged center line C, so that the fixed part 212 of the first electric push rod 21 may be pivoted around the hinged center line C relative to the pivoting bracket 80, as s result, the angle adjusting motor 22, the installing support 23 and the shooting apparatus 200 may be pivoted relative to the pivoting bracket 80, thereby adjusting the shooting angle. More specifically, the first electric push rod 21 is configured to adjust the height position of the shooting apparatus 200 fixed on the installing support 23, and the angle adjusting motor 22 is configured to adjust the angle of the shooting apparatus 200. In addition, the angle of the shooting apparatus 200 may be also adjusted by pivoting the fixed part 212 of the first electric push rod 21 about hinged center line C. Specifically, in FIG. 1 and FIG. 2, a plurality of adjusting holes 82 are formed on the pivoting bracket 80 along the pivoting direction thereof (a counterclockwise or clockwise direction of the pivoting bracket 80 in FIG. 1). A matching hole 213 is provided on the fixed part 212 to match with the adjusting holes 82. As an embodiment, one matching hole 213 is configured. A pin 24 is inserted into and matching hole 213 and one of the adjusting holes 82, to obtain a different angle for the first electric push rod 21. That is to say, the angle of the first electric push rod 21, namely the shooting apparatus 200 may be adjusted manually. It should be noted that, the angle adjusting motor 22 may drive the installing support 23 relative to the first electric push rod 21 in the range of 270 degrees, the first electric push rod 21 may be pivoted about the hinged center line C relative to the pivoting bracket 80 in the range of 60 degrees, which is not limited here. It is understood that the angle adjusting motor 22 may be controlled by the controller 67, if any.

Referring to FIG. 1 to FIG. 6, the folding process of the surround shooting device 100 in the first embodiment is illustrated. When there is a need to fold the surround shooting device 100 in the state shown in FIG. 1 into the state shown in FIG. 5 and FIG. 6, the push part 211 of the first electric push rod 21 is retracted downward relative to the fixed part 212, thus driving the angle adjusting motor 22, the installing support 23 together with the shooting apparatus 200 to slide downward. After the sliding is in place, the angle adjusting motor 22 then drives the installing support 23 together with the shooting apparatus 200 to move closer to the first electric push rod 21, until the state shown in FIG. 6 is reached. At the same time, the user manually makes the first electric push rod 21 move closer to the pivoting bracket 80 and the annular spinner 40, until the fixed buckle 64 on the fixed part 212 is buckled with the bottom 46 of the annular spinner 40, as shown in FIG. 6, and the folding process of the surround shooting device 100 is completed so far. When there is a need to drag the surround shooting device 100, the user needs to switch the folding position of the pivoting frame 70 to the unfolding position, so that the user may drag the device 100 by holding the handle 65. It should be noted that, before the first electric push rod 21 together with the pivoting bracket 80 moves close to the annular spinner 40 as the state in FIG. 6, it is necessary to insert the pin 24 into the matching hole 213 and that adjusting hole 82 nearest to the annular spinner 40.

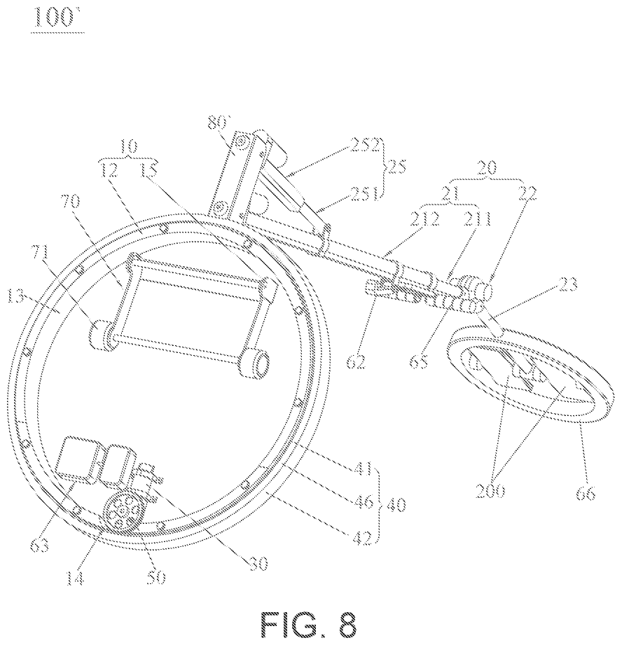

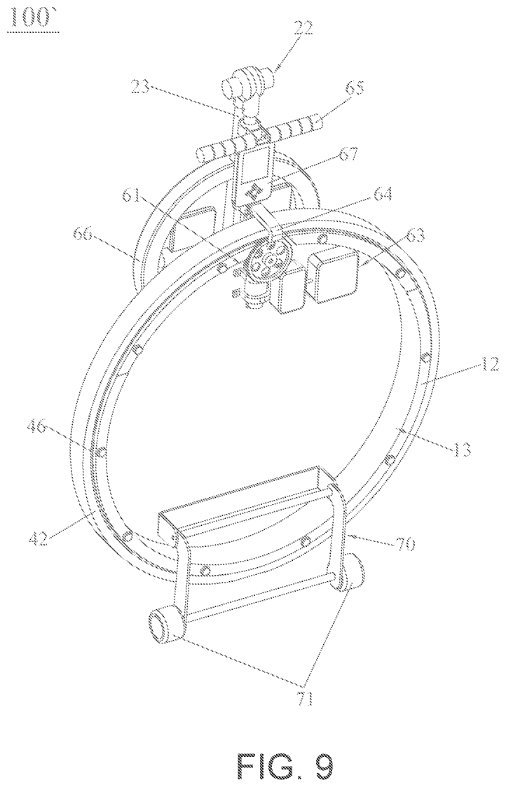

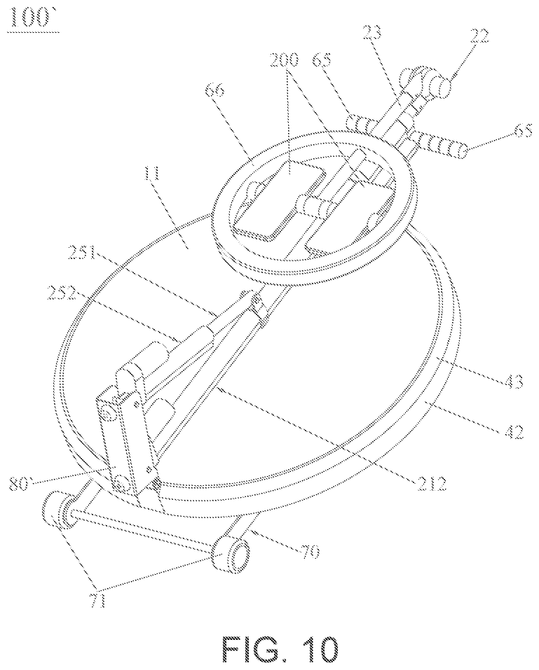

Referring to FIG. 7 to FIG. 10, the basic structure of the surround shooting device 100′ in the second embodiment is the same as that of the first embodiment, and some differences follow.

Instead of the manual angle adjustment between the first electric push rod 21 and the pivoting bracket 80 in the first embodiment, an electrical angle adjustment is used in the second embodiment. Specifically, in the second embodiment, a second electric push rod 25 is further included, the push part 251 of the second electric push rod 25 is hinged with the fixed part 212 of the first electric push rod 21, and the fixed part 252 of the second electric push rod 25 is hinged with the pivoting bracket 80′, thus the first electric push rod 21 is driven by the second electric push rod 25 to pivot about the hinged center line C relative to the pivoting bracket 80′. In this condition, the adjusting holes 82, the pin 24 and the matching hole 213 are unnecessary.

Other same or similar structures of the surround shooting device 100′ in the second embodiment may be referred to that in the first embodiment, which are not repeated here. In addition, the second electric push rod 25 may be controlled by the controller 67, if any.

Referring to FIG. 7 to FIG. 10, the folding process of the surround shooting device 100′ of the second embodiment is explained. As discussed above, the second embodiment applies electrical angle adjustment, that is, the second electric push rod 25 drives the first electric push rod 21 to pivot relative to the pivoting bracket 80′. Other processes are the same with those in the first embodiment, thus are omitted here.

Compared with the prior art, the annular spinner 40 is set outside the platform 10 and is rotatable around the platform 10, the top 11 of the platform 10 is protuberant over the annular spinner 40, and the bottom 12 of platform 10 is extended out of the annular spinner 40, thus the force suffered by the platform may be directly transmitted to the ground, etc., which will not directly affect the stability of the whole structure of the device 100. At the same time, the annular spinner 40 is provided with a gear ring structure 41 facing the shooting station 10 and extending along the rotation direction of the annular spinner 40, the gear 50 is located in the gear ring structure 41 and meshes with the gear ring structure 41, and the rotating motor 30 is installed on the shooting station 10 and drives the gear 50 to rotate. The rotating gear 50 drives the annular spinner 40 and the shooting stand 20 to rotate around the shooting stand 10 through the gear ring structure 41. In this way, the rotation structures among the rotating motor 30, the annular spinner 40 and the shooting stand 20 are simplified. Moreover, the lower end of the shooting stand 20 is connected at the annular spinner 40 which is connected around the platform 10, thus the suspension length of shooting stand 20 relative to the annular spinner 40 may be reduced, thereby improving the stability and the reliability of the rotation.

It is noted that, the push part 211 or 251 in the first electric push rod 21 and the second electric push rod 25 is extendable relative to the fixed part 212 or 252. In addition, lighting effects may be arranged on the side wall 42 of the annular spinner 40 to create unique atmosphere, and a ring fill light 66 may be installed on the installing support 23 and arranged around the shooting apparatus 200, so as to provide fill light to the scene where the light is insufficient. In addition, the aforementioned controller 67 may be provided with a built-in program and a wireless receiving module, a remote controller or a mobile phone may be used for the remote connection. The remote connection and control are well known in the art, which will not be described in detail therefore.

The above-mentioned embodiments only denote several embodiments of the present application, and the descriptions thereof are relatively specific and detailed, but should not be construed as limiting the scope of the patent application. It should be pointed out that for those skilled in the art, several modifications and improvements can be made without departing from the concept of the present application, which all belong to the protection scope of the present application. Therefore, the scope of protection of the patent of the present application shall be subject to the appended claims.

What is claimed is:

1. A surround shooting device, comprising a platform for standing, a shooting stand for fixing a shooting apparatus, a rotating motor, an annular spinner and a gear;
wherein the annular spinner is rotatable and arranged around the platform, the annular spinner is provided with a gear ring structure extended along a rotation direction of the annular spinner, the platform has a top that is protuberant over the annular spinner and a bottom extended from the annular spinner, a lower end of the shooting stand is connected with the annular spinner, the gear is located in and meshes with the gear ring structure, the rotating motor is installed in the platform and drives the gear to rotate, accordingly, the annular spinner together with the shooting stand is actuated to rotate around the platform.

2. The surround shooting device according to claim 1, wherein the platform is provided with a receiving chamber running through the bottom of the platform, and a notch formed at a side of the platform and communicated with the receiving chamber; the rotating motor and the gear are received in the receiving chamber, and the gear is further extended out of the notch.

3. The surround shooting device according to claim 2, wherein the rotating motor and the gear are arranged flat respectively.

4. The surround shooting device according to claim 3, further comprising a worm gear mechanism, a ring clamp, and a battery box, which are received in the receiving chamber, wherein the worm gear mechanism is mounted between the rotating motor and the gear, the ring clamp encircles the rotating motor and is fixedly connected with the platform, and the battery box is electrically connected with the rotating motor.

5. The surround shooting device according to claim 2, wherein a pivoting frame is included, a hinge structure is received in the receiving chamber of the platform, the pivoting frame has a first end hinged with the hinge structure and a second end provided with a wheel, and the pivoting frame is pivoted relative to the platform to provide a folding position and an unfolding position, in the unfolding position, the pivoting frame together with the wheel is unfolded out of the receiving chamber, the surround shooting device is capable of rolling or sliding; while in the folding position, the pivoting frame is completely received in the receiving chamber.

6. The surround shooting device according to claim 2, wherein a pivoting bracket is located at a side wall of the annular spinner, a hinge element is horizontally arranged at a top of the annular spinner, the pivoting bracket is provided with a lug hinged with the hinge element, the lower end of the shooting stand is connected with the pivoting bracket, the shooting stand together with the pivoting bracket is pivoted or swings to fold or unfold relative to the platform, and the pivoting bracket is pressed against a sidewall of the annular spinner when the pivoting bracket is unfolded in place.

7. The surround shooting device according to claim 6, wherein the shooting stand is provided with a fixed buckle and a handle located above the fixed buckle, the fixed buckle is configured to buckle with a bottom of the annular spinner or the platform when the shooting stand is folded in place.

8. The surround shooting device according to claim 6, wherein the shooting stand comprises a first electric push rod, an angle adjusting motor and an installing support connected with the shooting apparatus, the angle adjusting motor is connected between a lower end of the installing support and a push part of the first electric push rod, a fixed part of the first electric push rod is hinged with the pivoting bracket to form a hinged center line, and the angle adjusting motor is configured to drive the installing support to pivot relative to the first electric push rod to fold or unfold.

9. The surround shooting device according to claim 8, wherein a plurality of adjusting holes are formed on the pivoting bracket along a pivoting direction thereof, a matching hole is provided on the fixed part of the first electric push rod to match with the adjusting holes, and a pin is inserted into and matching hole and one of the adjusting holes.

10. The surround shooting device according to claim 8, wherein the shooting stand further comprises a second electric push rod, a push part of the second electric push rod is hinged with the fixed part of the first electric push rod, and a fixed part of the second electric push rod is hinged with the pivoting bracket.
